(19) United States
(12) Patent Application Publication
(10) Pub. No.: US 2015/0160711 A1
(43) Pub. Date: Jun. 11, 2015

(54) METHOD FOR SWITCHING A DEVICE BETWEEN HIBERNAT MODE AND WAKE-UP

(71) Applicant: Yingjiang Zhu, Shanghai (CN)

(72) Inventor: Yingjiang Zhu, Shanghai (CN)

(73) Assignee: Harman International Industries, Inc., Stamford, CT (US)

(21) Appl. No.: 14/391,977

(22) PCT Filed: Jul. 12, 2012
(86) PCT No.: PCT/CN2012/078567

§ 371 Date: Oct. 10, 2014

(51) Int. Cl. G06F 1/32

(52) U.S. Cl. CPC G06F 1/3209

(57) ABSTRACT

A system and a method for switching a client device between hibernate mode and wake-up are provided. A client device connected to a host device through a network is configured to: receive a hibernate instruction from a user; send a hibernate request to a host device through the network upon receipt of the hibernate instruction; receive a hibernate permission from the host device; send image data of a volatile memory device of the client device to the host device upon receipt of the hibernate permission; receive a wake-up instruction from a user; send a wake-up request to the host device upon receipt of the wake-up instruction; and receive the image data from the host device, and write the image data back into the volatile memory device, after the wake-up request is sent to the host device.

### TECHNICAL FIELD

The present disclosure generally relates to a power management method for electronic devices, and particularly to a method for switching an electronic device between hibernate mode and wake-up.

### BACKGROUND

Generally, electronic devices, such as computers, printers and the like, have a variety of power modes to save power. Among the commonly used power modes, the hibernate mode provides faster start-up than cold start, and saves more power than sleep (stand-by) mode.

FIG. 1 illustrates a schematic block diagram showing a conventional method for switching an electronic device 100 between hibernate mode and wake-up. When the electronic device 100 receives a hibernate instruction, an image of a volatile memory device such as a random access memory device (RAM) 101 of the electronic device 100 is transmitted into a non-volatile data storage device such as a hard disk 103 of the electronic device 100. Then the electronic device 100, as well as the RAM 101 and the hard disk 103, are powered off. An image of a volatile memory device may be referred to as “image data” hereinafter.

When the electronic device 100 receives a wake-up instruction, it is powered on, and the image data stored in the hard disk 103 will be written back into the RAM 101, thus the electronic device 100 can restore the status when it is put into hibernate mode.

However, in a conventional method, an electronic device must have a non-volatile storage device for storing image data to switch between hibernate mode and wake-up.

### SUMMARY

According to one embodiment of the present disclosure, a host device for switching a client device connected to the host device through a network between hibernate mode and wake-up is provided. The host device includes a first control device and a data storage device. When the host device receives through the network a hibernate request from the client device, the first control device will check whether the host device is ready to receive image data of a volatile memory device of the client device. If yes, the first control device will control the host device to send a hibernate permission to the client device through the network. When the host device receives through the network the image data from the client device, the first control device will control the host device to store the image data in the data storage device. When the first control device receives a wake-up request from the client device, it will control the host device to send the image data stored in the data storage device to the client device through the network.

In some embodiments, when the host device receives through the network a hibernate request from the client device, and if it is not ready to receive the image data, then the first control device will control the host device to send a hibernate rejection to the client device.

In some embodiments, the network may be Ethernet, LAN, WLAN, wireless mobile communication network, internet, intranet, or any other suitable network. In a preferred embodiment, the network may be Ethernet.

According to another embodiment of the present disclosure, a client device capable of switching between hibernate mode and wake-up through a network is provided. The client device includes a second control device and a volatile memory device. When the client device receives a hibernate instruction, the second control device will control the client device to send a hibernate request to a host device connected to the client device through the network. When the client device receives a hibernate permission from the host device through the network, the second control device will control the client device to send image data of the volatile memory device to the host device through the network. When the client device receives a wake-up instruction, the second control device will control the client device to send a wake-up request to the host device through the network. When the client device receives the image data from the host device through the network, the second control device will write the image data back into the volatile memory device to restore its status when the client device is switched to hibernate mode.

According to another embodiment of the present disclosure, a system for switching a client device in the system between hibernate mode and wakeup is provided. The system includes a host device and a client device connected to the host device through a network. The host device includes a first control device and a data storage device. The client device includes a second control device and a volatile memory device. When the client device receives a hibernate instruction, the second control device controls the client device to send a hibernate request to the host through the network, the first control device controls the host device to send a hibernate permission or a hibernate rejection to the client device through the network according to whether the host device is ready for storing image data of the volatile memory device of the client device, when the client device receives a hibernate permission, the second control device controls the client device to send the image data to the host device through the network, and the first control device controls the host device to store the image data in the data storage device. When the client device receives a wake-up instruction, the second control device controls the client device to send a wake-up request to the host device through the network, the first control device controls the host device to send the image data to the client device through the network, and when the client device receives the image data, the second control device controls the client device to write the image data into the volatile memory device.

According to another embodiment of the present disclosure, a method for switching a client device connected to a host device through a network to hibernate mode is provided. The method includes: receiving from the client device through the network a request for switching from a current mode to hibernate mode; checking whether the host device is ready to receive image data of a volatile memory device of the client device; if the host device is ready to receive the image data, sending a hibernate permission to the client device through the network; and receiving the image data from the client device through the network, and storing the received image data in a data storage device of the host device.

According to another embodiment of the present disclosure, a method for switching a client device connected to a host device through a network from hibernate mode to wake-up is provided. The method includes: receiving from the client device through the network a request for switching from hibernate mode to wake-up; and sending a corresponding set of image data stored in a data storage device of the host device to the client device through the network.

According to another embodiment of the present disclosure, a method for switching a client device connected to a host device through a network to hibernate mode is provided. The method includes: sending a request for switching from a current mode to hibernate mode to the host device through the network; receiving a hibernate permission from the host device through the network; and sending image data of a volatile memory device of the client device to the host device through the network for storage, where the image data represents the status of the client device when it is switched to hibernate mode.

According to another embodiment of the present disclosure, a method for switching a client device connected to a host device through a network from hibernate mode to wake-up is provided. The method includes: sending a request for switching from hibernate mode to wake-up to the host device through the network; receiving image data of a volatile memory device of the client device from the host device through the network, where the image data were stored in the host device previously; and writing the image data into the volatile memory device of the client device to restore its status when it is switched to hibernate mode.

By employing the methods and devices of the present disclosure, it is not necessary that a client device must have a non-volatile data storage device to store image data of its volatile memory device when it is switched to hibernate mode, thus much hardware resources and power can be further saved.

### BRIEF DESCRIPTION OF THE DRAWINGS

FIG. 1 illustrates a schematic block diagram showing a conventional method for switching an electronic device between hibernate mode and wake-up;

FIG. 2 illustrates a schematic block diagram of a system that can switch a client device in the system between hibernate mode and wake-up according to one embodiment of the present disclosure;

FIG. 3 illustrates a schematic block diagram of a host device in FIG. 2 according to a specific embodiment of the present disclosure;

FIG. 4 illustrates a schematic block diagram of a client device in FIG. 2 according to a specific embodiment of the present disclosure;

FIG. 5 illustrates a schematic diagram of a system including a plurality of client devices according to one embodiment of the present disclosure;

FIG. 6 illustrates a schematic flow chart of a method S100 for switching a client device connected to a host device through a network to hibernate mode according to one embodiment of the present disclosure;

FIG. 7 illustrate a schematic flow chart of a method S200 for switching a client device connected to a host device through a network from hibernate mode to wake-up mode according to one embodiment of the present disclosure;

FIG. 8 illustrates a schematic flow chart of a method S300 for switching a client device connected to a host device through a network to hibernate mode according to one embodiment of the present disclosure; and

FIG. 9 illustrate a schematic flow chart of a method S400 for switching a client device connected to a host device through a network from hibernate mode to wake-up mode according to one embodiment of the present disclosure.

### DETAILED DESCRIPTION

Additional features and advantages of the present disclosure will become apparent from the following more particular description, as illustrated in conjunction with the accompanying drawings.

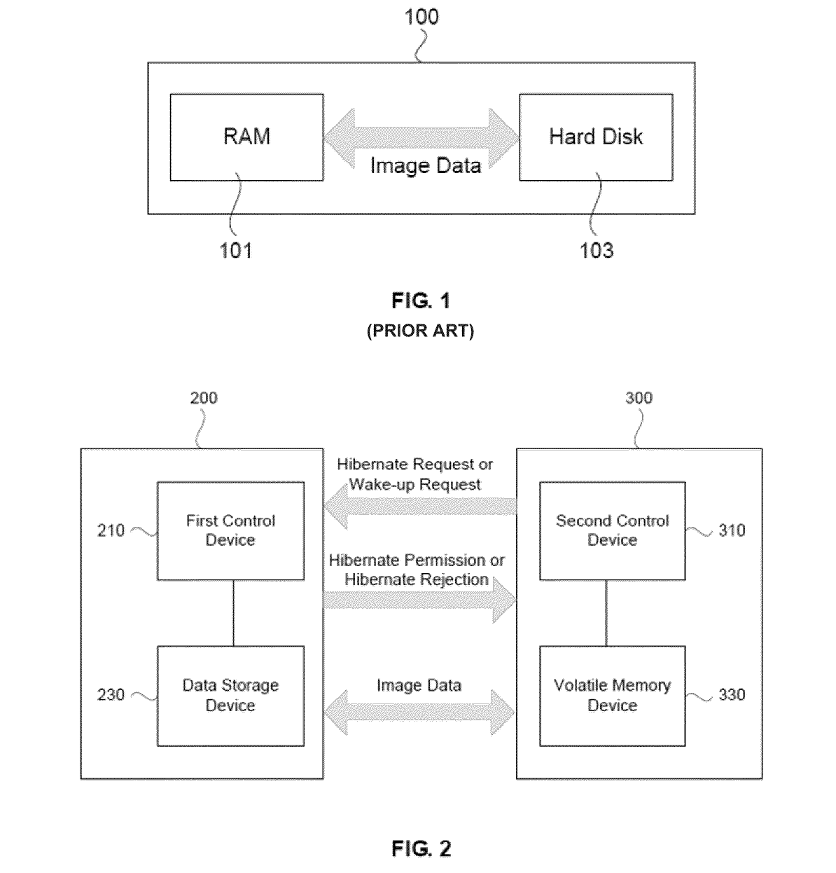

FIG. 2 illustrates a schematic block diagram of a system that can switch a client device in the system between hibernate mode and wake-up according to one embodiment of the present disclosure. With reference to FIG. 2, the system includes a host device 200 and a client device 300 configured in a same network.

The network may be Ethernet, LAN, WLAN, wireless mobile communication network, internet, or intranet. In a preferable embodiment, the network is Ethernet.

The host device 200 may be a computer or other devices which are capable of running management programs. Referring to FIG. 2, the host device 200 includes a first control device 210 and a data storage device 230.

Referring still to FIG. 2, the client device 300 includes a second control device 310 and a volatile memory device 330. It could be understood that, the volatile memory device 330 is adapted for storing temporary data, and will lose the temporary data when it is powered off. For example, the volatile memory device 330 may be a random access memory (RAM). In hibernate mode, as power may be no longer provided to the client device 300, image data of the volatile memory device 330 of the client device 300 should be stored in a storage device. It should be noted that, in the present disclosure, “image data” means real-time data which represents an image of the volatile memory device of the client device, and rewriting the image data into the volatile memory will bring the client device back to its status when it is switched to hibernate mode.

When the client device 300 receives an instruction, either hibernate or wake-up, the second control device 310 controls the client device 300 to send a request accordingly to the host device 200 through the network. In some embodiments, the second control device 310 controls the client device 300 to broadcast the request to all devices connected to the network. After the host device 200 receives the request, the first control device 210 controls the host device 200 to switch the client device 300 between hibernate mode and wake-up according to the request.

For example, if the request is a hibernate request, the first control device 210 checks whether the host device 200 is ready to receive and store the image data of the client device 300, then controls the host device 200 to send a hibernate permission or a hibernate rejection to the client device 300 through the network accordingly. If the client device 300 receives a hibernate permission, the second control device 310 controls the client device 300 to send the image data of the volatile memory device 330 to the host device 200 through the network. If the client device 300 receives a hibernate rejection, the second control device 310 controls the client device 300 to wait and/or keep sending hibernate requests to the host device 200 through the network. After the host device 200 receives the image data of the volatile memory device 330 of the client device 300, the first control device 210 controls the host device 200 to store the image data into the data storage device 230. The data storage device 230 may be a volatile memory device (such as a RAM) or a non-volatile memory device (such as a hard disk) of the host device 200. Thereafter, power supplied to the client device 300 can be cut off. Thus, the client device 300 is switched to hibernate mode.

If the request is a wake-up request, the first control device 210 controls the host device 200 to send the image data of the volatile memory device 330 to the client device 300 through the network. The image data were previously sent from the client device 300 to the host device 200 through the network, and stored in the data storage device 230. After the client device 300 receives the image data, the second control device 310 controls the client device 300 to write the image data into the volatile memory device 330. Therefore, the client device 300 recovers its status when it is switched to hibernate mode, and the client device 300 is switched to wake-up. It should be noted that before the image data is written back into the volatile memory device 330, power is provided to the client device 300, or at least to the volatile memory device 330.

Specific structures and components of the host device 200 and the client device 300 will be illustrated hereinafter in specific embodiments.

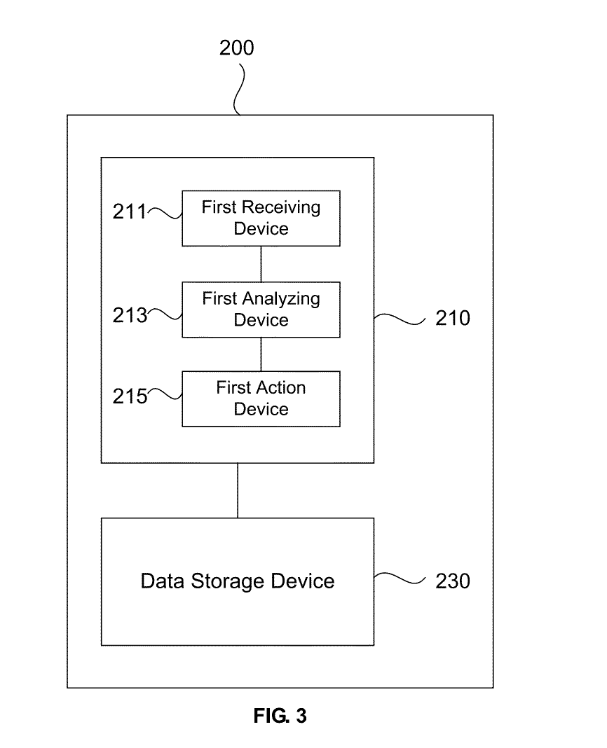

FIG. 3 illustrates a schematic block diagram of the host device 200 in FIG. 2 according to a specific embodiment of the present disclosure. Referring to FIG. 3, the first control device 210 of the host device 200 includes a first receiving device 211, a first analyzing device 213 and a first action device 215. The first receiving device 211 is adapted for receiving data sent from the client device 300 through the network. The first analyzing device 213 is adapted for analyzing the data received by the first receiving device 211. As described above, the data received by the first receiving device 211 may be a hibernate request, a wake-up request or image data of the volatile memory device 330 of the client device 300. According to the analyzing result, different operations may be performed by the first action device 215.

Specifically, if the data received by the first receiving device 211 is a hibernate request, the first action device 215 checks whether the host device 200 is ready to receive and store image data. If yes, the first action device 215 sends a hibernate permission to the client device 300 through the network; if no, the first action device 215 sends a hibernate rejection to the client device 300 through the network.

If the data received by the first receiving device 211 is image data, the first action device 215 is adapted for storing the image data into the data storage device 230.

If the data received by the first receiving device 211 is a wake-up request, the first action device 215 sends the image data stored in the data storage device 230 to the client device 300 through the network.

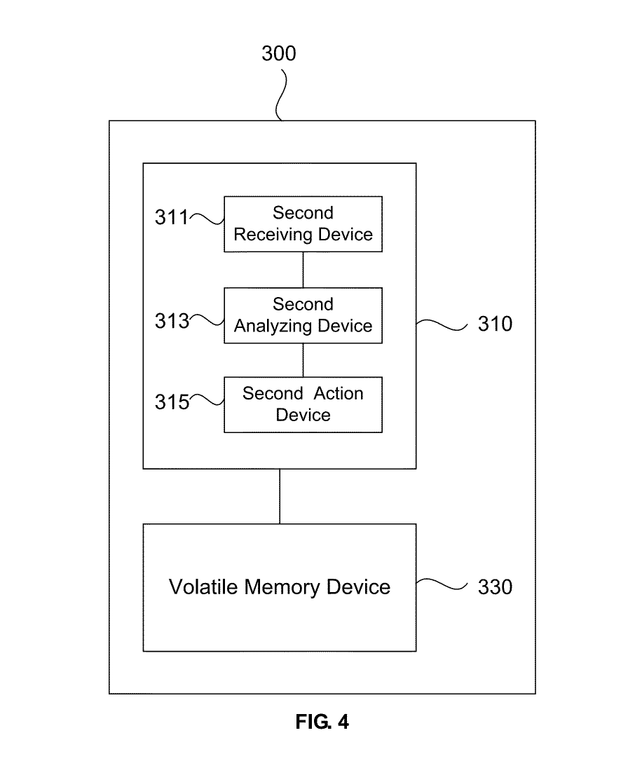

FIG. 4 illustrates a schematic block diagram of the client device 300 in FIG. 2 according to a specific embodiment of the present disclosure. Referring to FIG. 4, the second control device 310 of the client device 300 includes a second receiving device 311, a second analyzing device 313 and a second action device 315. The second receiving device 311 is adapted for receiving hibernate instructions, wake-up instructions, hibernate permissions, and image data. The second analyzing device 313 is adapted for analyzing the data received by the second receiving device 311. According to the analyzing result, the second action device 315 may perform different operations.

If the data received by the second receiving device 311 is a hibernate instruction or wake-up instruction from a user, the second action device 315 is adapted for sending to the host device 200 through the network a hibernate request or wake-up request accordingly. If the data received by the second receiving device 311 is a hibernate permission from the host device 200, the second action device 315 is adapted for sending the image data to the host device 200 through the network. If the data received by the second receiving device 311 is image data, the second action device 315 is adapted for writing the image data back into the volatile memory device 330 to recover its status when the client device 300 is switched to hibernate mode.

In an exemplary embodiment, the client device 300 may further include a human-machine interface adapted for inputting the instruction by a user.

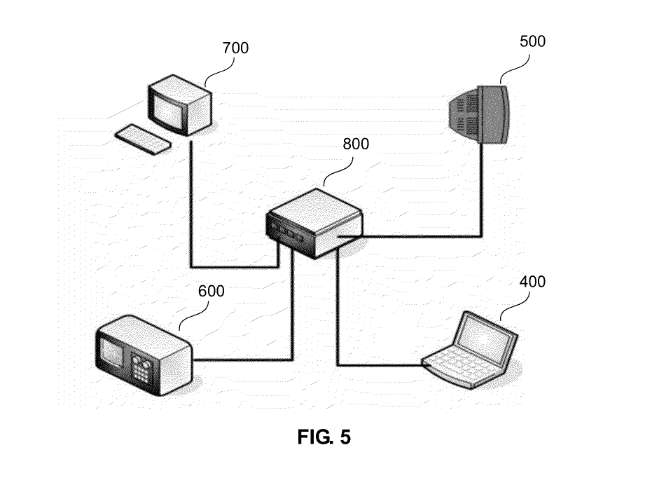

It should be noted that although only one client device is configured in the system as described above, the system may include a plurality of client devices. FIG. 5 illustrates a schematic diagram of a system including a plurality of client devices according to one embodiment of the present disclosure. Referring to FIG. 5, a host device 400 and a plurality of client devices 500˜700 are configured in a network through a switch 800. Image data of each of the client devices 500˜700 can be stored in the host device 400 during hibernate mode and can be written back into the corresponding client device during wake-up.

The system may be applied in a vehicular system, a music hall, a home media system or other occasions in which devices without non-volatile memory devices need to be switched to hibernate mode.

By employing the above described devices of the present disclosure, it is not necessary that a client device must have a non-volatile data storage device to store image data, thus much hardware resources and power can be further saved.

Embodiments of the present disclosure further provide methods for switching a device between hibernate mode and wake-up.

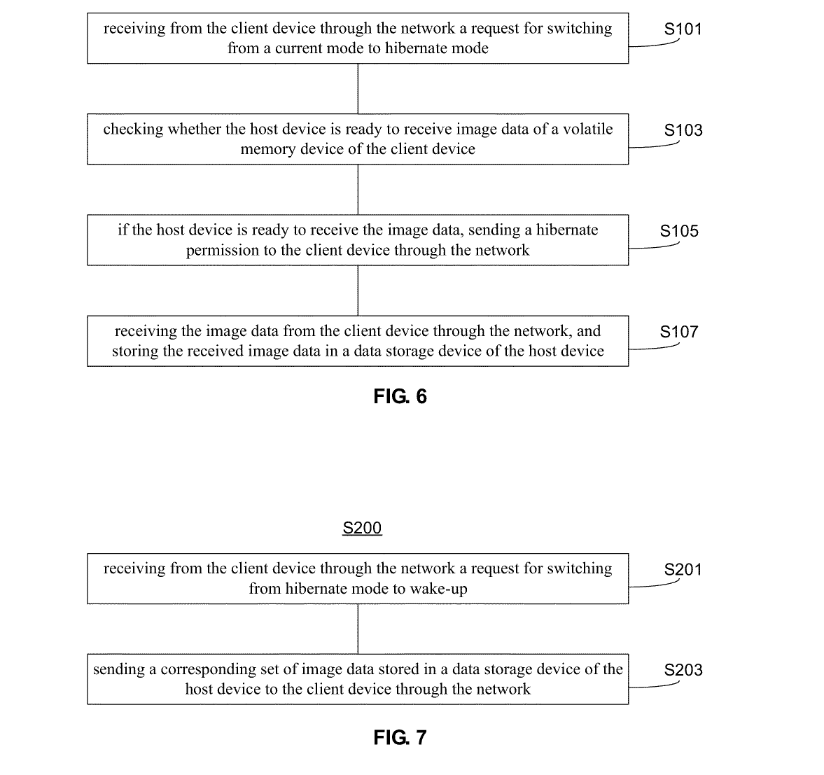

FIG. 6 illustrates a schematic flow chart of a method S100 for switching a client device connected to a host device through a network to hibernate mode according to one embodiment of the present disclosure. Referring to FIG. 6, the method S100 includes: S101, receiving from the client device through the network a request for switching from a current mode to hibernate mode; S103, checking whether the host device is ready to receive image data of a volatile memory device of the client device; S105, if the host device is ready to receive the image data, sending a hibernate permission to the client device through the network; and S107, receiving the image data from the client device through the network, and storing the received image data in a data storage device of the host device.

In S101, a request is received from the client device by the host device through the network. The request is to switch the client device from a current mode to hibernate mode.

Referring to the above described embodiment in which a host device is provided, the request may be received, analyzed and identified by a first control device of the host device.

In S103, the host device is checked to determine whether it is ready to receive image data of a volatile memory device of the client device.

As described above, in “hibernate mode” of the client device, the client device may be cut off from its power supply to save power. In order to keep the image data of the volatile memory device of the client device, the image data is stored in the host device. Therefore, once the client device is to wake-up, the image data may be restored into its volatile memory device and the client device may revert to its status when it is switched to hibernate mode. The host device may be checked, for example, by a first action device thereof. If the host device is not ready to receive the image data, for example, its data storage device can not store any more data or the data storage device is occupied, it will send a hibernate rejection to the client device through the network.

In S105, if the host device is ready to receive the image data, a hibernate permission is sent to the client device through the network.

The client device receives and analyzes the hibernate permission, and accordingly send the image data to the host device through the network.

In S107, the image data is received from the client device through the network and is stored in a data storage device of the host device.

The data storage device of the host device may be a non-volatile or volatile memory device of the host device. Since the host device may be always provided with power, the image data may be kept in the data storage device of the host device.

Therefore, the client device is switched to hibernate mode.

FIG. 7 illustrates a schematic flow chart of a method S200 for switching a client device connected to a host device through a network from hibernate mode to wake-up mode according to another embodiment of the present disclosure. With reference to FIG. 7, the method S200 includes: S201, receiving from the client device through the network a request for switching from hibernate mode to wake-up; and S203, sending a corresponding set of image data stored in a data storage device of the host device to the client device through the network.

Specifically, in S201, a request is received from the client device through the network. The request is to switch the client device to wake-up mode from hibernate mode, which means the client device is in hibernate mode right now and at least one set of image data of its volatile memory device is stored in the data storage device of the host device. Each of the at least one set of image data correspond to a wake-up mode of the client device. For example, the client device may include several functions like sound recording, video displaying, and the like. Each function corresponds to a wake-up mode. After the host device receives and analyzes the request, in S201, the host device sends the corresponding set of image data stored in its data storage device to the client device through the network. The client device receives the set of image data and writes the image data into its volatile memory device to restore its status when it is switched to hibernate mode. Therefore, the client device is switched to a corresponding wake-up mode.

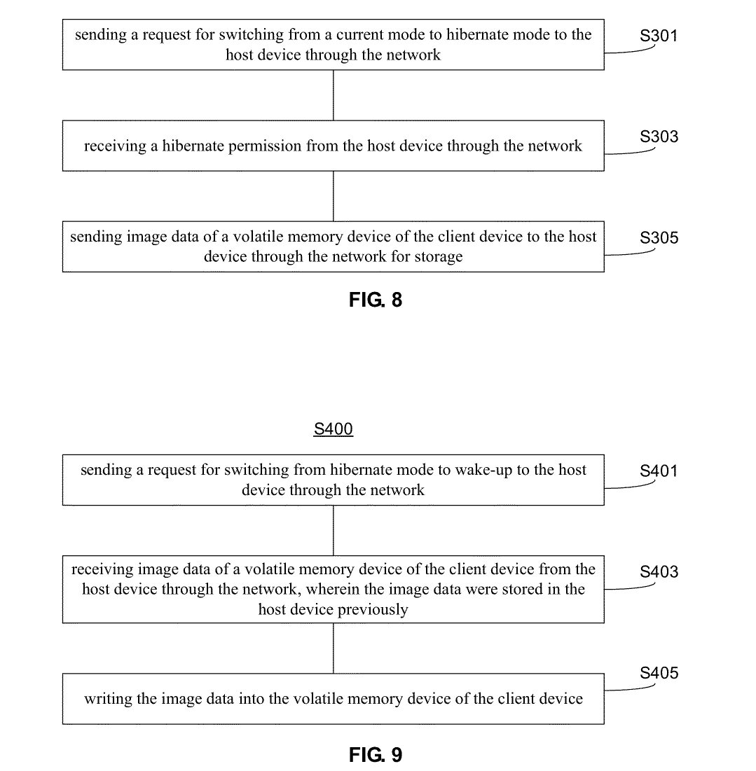

FIG. 8 illustrates a schematic flow chart of a method S300 for switching a client device connected to a host device through a network to hibernate mode according to another embodiment of the present disclosure. With reference to FIG. 8, the method S300 includes: S301, sending a request for switching from a current mode to hibernate mode to the host device through the network; S303, receiving a hibernate permission from the host device through the network; and S305, sending image data of a volatile memory device of the client device to the host device through the network for storage.

Specifically, in S301, a request is sent by the client device to the host device through the network. In some embodiments, the request may be broadcast to all devices connected to the network. The request is to switch the client from a current mode to hibernate mode. The host device may receive and analyzes the request, and if it is ready to receive the image data, it will send a hibernate permission. In S303, the client device receives the hibernate permission through the network. And accordingly, in S305, the client device sends the image data to the host device though the network. The image data may be stored and kept in the host device. The power supply of the client device may be cut off then. Therefore, the client device is switched to hibernate mode. More details can be referred to the above descriptions.

FIG. 9 illustrate a schematic flow chart of a method S400 for switching a client device connected to a host device through a network from hibernate mode to wake-up mode according to another embodiment of the present disclosure. With reference to FIG. 9, the method S400 includes: S401, sending a request for switching from hibernate mode to wake-up to the host device through the network; S403, receiving image data of a volatile memory device of the client device from the host device through the network, wherein the image data were stored in the host device previously; and S405, writing the image data into the volatile memory device of the client device.

Specifically, in S401, the client device sends the request to the host device through the network. In some embodiments, the request may be broadcast to all devices connected to the network. The request is to switch the client device from hibernate mode to wake-up mode, which means the client device is in hibernate mode right now and the image data of its volatile memory device are stored in the host device. According to the request, the host device may send the image data back to the client device. In S403, the client device receives the image data through the network. And in S405, the client device writes the image data into its volatile device. Thus, the client device reverts to its previous status before hibernate, which means the client device is switched from hibernate mode to wake-up mode.

By employing the methods described above, there is no need for a client device to have a non-volatile data storage device to store image data of its volatile memory device when it is switched to hibernate mode, thus much hardware resources and power can be further saved.

The disclosure is disclosed, but not limited, by preferred embodiments as above. Based on the disclosure of the disclosure, those skilled in the art can make any variation and modification without departing from the scope of the disclosure. Therefore, any simple modification, variation and polishing based on the embodiments described herein is within the scope of the present disclosure.

1. A host device for switching a client device coupled to the host device through a network between hibernate mode and wake-up, comprising:
a first control device, and a data storage device,
where the first control device is adapted for controlling the host device to: receive a hibernate request from the client device; check whether the host device is ready to receive image data of a volatile memory device of the client device upon receipt of the hibernate request; send a hibernate permission to the client device if the host device is ready to receive the image data; receive the image data from the client device after the hibernate permission is sent to the client device, and store the image data into the data storage device; receive a wake-up request from the client device; and send the image data stored in the data storage device to the client device upon receipt of the wake-up request.

2. The host device according to claim 1, wherein the first control device comprises:
a first receiving device, adapted for receiving data from the client device through the network;
a first analyzing device, adapted for analyzing the data received by the first receiving device to determine whether the received data is a hibernate request, a wake-up request, or image data; and
a first action device, adapted for checking whether the host device is ready to receive image data if the received data is a hibernate request, sending a hibernate permission to the client device through the network if the host device is ready to receive image data, or a hibernate rejection if the host device is not ready to receive image data; storing the received data in the data storage device if the received data is image data; and sending the image data stored in the data storage device to the client device through the network if the received data is a wake-up request.

3. A client device capable of switching between hibernate mode and wake-up through a network, comprising a second control device and a volatile memory device, where the second control device is configured to:
control the client device to send a hibernate request to a host device connected to the client device through the network when the client device receives a hibernate instruction from a user;
control the client device to send image data of the volatile memory device to the host device through the network when the client device receives a hibernate permission from the host device;
control the client device to send a wake-up request to the host device through the network when the client device receives a wake-up instruction from a user; and
control the client device to write image data into the volatile memory device when the client device receives the image data from the host device through the network.

4. The client device according to claim 3, wherein the second control device comprises:
a second receiving device, adapted for receiving a hibernate instruction or a wake-up instruction from a user, and receiving a hibernate permission and image data from the host device;
a second analyzing device, adapted for analyzing the data received by the second receiving device to determine whether the received data is a hibernate instruction, a wake-up instruction, a hibernate permission, or image data; and
a second action device, adapted for sending to the host device through the network a hibernate request or wake-up request if the received data is a hibernate instruction or wake-up instruction, respectively; sending image data of the volatile memory device to the host device through the network if the received data is a hibernate permission; and writing the received data into the volatile memory device to restore a status of the client device's from when the client device was switched to hibernate mode if the received data is image data.

5.-11. (canceled)

12. The host device according to claim 1, wherein checking whether the host device is ready to receive the image data of the volatile memory device of the client device comprises checking whether the data storage device is able to store more data or whether the data storage device is occupied.

13. The host device according to claim 12, wherein the first control device is further adapted for controlling the host device to send a hibernate rejection to the client device through the network responsive to determining that the data storage device is unable to store more data or the data storage device is occupied.

14. The client device according to claim 3, wherein sending the hibernate request to the host device further comprises broadcasting the hibernate request to a plurality of devices connected to the network.

15. The client device according to claim 3, wherein the second control device is further configured to control the client device to switch to the hibernate mode responsive to receiving the hibernate permission from the host device.

16. The client device according to claim 15, wherein switching to the hibernate mode comprises cutting off the client device from a power supply to save power.

17. The client device according to claim 3, wherein the second control device is further configured to control the client device to receive the image data from the host device after the wake-up request is sent to the host device.

18. A method for switching a client device connected to a host device through a network between a hibernate mode and a wake-up, the method comprising:
transmitting a request for switching from a current mode to a hibernate mode from the client device to the host device through the network;
receiving, at the client device, a hibernate permission from the host device through the network; and
sending image data of a volatile memory device of the client device from the client device to the host device through the network.

19. The method according to claim 18, further comprising checking whether the host device is ready to receive the image data of the volatile memory device of the client device, the hibernate permission being received at the client device if the host device is ready to receive the image data.

20. The method according to claim 19, wherein checking whether the host device is ready to receive the image data comprises checking whether a data storage device of the host device is able to store more data or is occupied.

21. The method according to claim 20, further comprising sending a hibernate rejection from the host device to the client device through the network responsive to determining that the data storage device of the host device is unable to store more data or the data storage device of the host device is occupied.

22. The method according to claim 18, further comprising switching the client device to the hibernate mode after sending the image data of the volatile memory device of the client device from the client device to the host device through the network.

23. The method according to claim 22, wherein switching the client device to the hibernate mode comprises cutting off the client device from a power supply to save power.

24. The method according to claim 18, further comprising storing the image data received from the client device in a data storage device of the host device.

25. The method according to claim 18, further comprising sending a request for switching from the hibernate mode to wake-up from the client device to the host device through the network.

26. The method according to claim 25, further comprising receiving, at the client device, the image data of the volatile memory device of the client device from the host device through the network, wherein the image data was stored in the host device prior to sending the request for switching from the hibernate mode to wake-up.

27. The method according to claim 26, further comprising writing the image data received from the host device into the volatile memory device of the client device to revert the client device to a previous status of the client device before the client device switched to the hibernate mode.
